(19) United States
(12) Patent Application Publication
(10) Pub. No.: US 2018/0033250 A1
(43) Pub. Date: Feb. 1, 2018

(54) SYSTEM, METHOD, AND GRAPHICAL USER INTERFACE FOR PRESENTING AND/OR PLAYING A GAME

(71) Applicants: Pete O'Heeron, Houston, TX (US); Scott A. Marrone, Nashville, TN (US)

(72) Inventors: Pete O'Heeron, Houston, TX (US); Scott A. Marrone, Nashville, TN (US)

(21) Appl. No.: 15/728,429

(22) Filed: Oct. 9, 2017

Related U.S. Application Data
(63) Continuation-in-part of application No. 14/980,245, filed on Dec. 28, 2015.

(51) Int. Cl. G07F 17/32; G06Q 30/02

(52) U.S. Cl. CPC G07F 17/3255; G07F 17/3295; G07F 17/3239; G07F 17/3279; G07F 17/3218; G06Q 30/0209; G06Q 30/0277

(57) ABSTRACT

Methods and systems are provided of providing an incentive to a player of a game on a computing device comprising the steps of receiving a player submission, determining whether or not the player submission is valid, if the player submission is valid, presenting the player with positive feedback, retrieving one or more player parameters from a data repository, determining whether or not the player is eligible for one or more awards, based at least in part on the one or more player parameters, if the player is eligible for at least one award, presenting the player with the one or more awards, and if the player submission is not valid, presenting the player with negative feedback.

### CROSS-REFERENCE TO RELATED APPLICATION

This application is a continuation-in-part of and claims benefit to U.S. patent application Ser. No. 14/980,245, filed on Dec. 28, 2015, which in turn claims benefit to U.S. Provisional Patent Application Ser. No. 62/096,994, filed on Dec. 26, 2014, both of which are incorporated by reference herein.

### TECHNICAL FIELD

The present disclosure is generally related to a system, apparatus, method, computer readable medium and graphical user interface for presenting a game and/or interacting with a user of a computing device. More particularly, the present disclosure is related to a user interactive game relating to music and/or to identify musical bands.

### BRIEF SUMMARY

Example embodiments of the present disclosure provide systems for providing an incentive to a player of a game on a computing device. Briefly described, in architecture, one example embodiment of the system, among others, can be implemented as follows: at least one memory operable to store computer-executable instructions, at least one communications interface to access the at least one memory, and at least one processor configured to access the at least one memory via the at least one communications interface and execute the computer-executable instructions to, receive a player submission, determine whether or not the player submission is valid, if the player submission is valid, present the player with positive feedback and determine, from a plurality of offers, at least one or more offers that the player is eligible for, based at least in part on one or more player parameters, present the player with the one or more offers, and if the player submission is not valid, present the player with negative feedback.

Embodiments of the present disclosure can also be viewed as providing methods for providing an incentive to a player of a game on a computing device. In this regard, one embodiment of such a method, among others, can be broadly summarized by the following steps: receiving a player submission, determining whether or not the player submission is valid, if the player submission is valid, then presenting the player with positive feedback, retrieving one or more player parameters from a data repository, determining whether or not the player is eligible for one or more awards, based at least in part on the one or more player parameters, if the player is eligible for at least one award, presenting the player with the one or more awards, and if the player submission is not valid, presenting the player with negative feedback.

According to yet another embodiment of the present disclosure, a method for providing an incentive to a player of a game on a computing device including the steps of receiving a player submission, determining whether or not the player submission is valid, if the player submission is valid, presenting the player with positive feedback, determining whether or not a player is eligible for a prize at the current stage of the game, if the player is eligible for a prize, retrieving one or more player parameters from a data repository, determining, from a plurality of prizes, at least one or more prize that the player is eligible for, based at least in part on one or more player parameters, and presenting the player with the one or more prizes.

Disclosed herein are a system, method, apparatus, computer readable media, and graphical user interface for presenting information and interacting with a user. Also disclosed are such a system, method, apparatus, and graphical user interface for presenting a game or gaming system and interacting with the user(s) therewith, via a graphical user interface on a computing device or console. In one aspect, the method is a computer-implemented method and the system may include a handheld or locally stationed device connected with one or more processor(s), a memory storing programmable instructions, and input/output user interface. According to a further aspect of the disclosure, the game is embodied, structured, and/or played on a graphical user interface of a mobile device. The game involves eliciting entries from a user(s) in response to one or more items of presented criteria.

### BRIEF DESCRIPTION OF THE DRAWINGS

A more complete and thorough understanding of the present embodiments and advantages thereof may be acquired by referring to the following description taken in conjunction with the accompanying drawings:

FIG. 1 illustrates an exemplary environment in which an embodiment in accordance with the present disclosure may be practiced.

FIG. 2 illustrates an example system for supporting provision of an interactive game according to an example embodiment of the disclosure.

FIGS. 3 A-C show exemplary screen shots of a game in accordance with one or more embodiments of the present disclosure.

FIGS. 4 A-B show exemplary screen shots of a game in accordance with one or more embodiments of the present disclosure.

FIGS. 5 A-C show exemplary screen shots of a game in accordance with one or more embodiments of the present disclosure.

FIG. 6 illustrates an exemplary user tier system in accordance with one or more embodiments of the present disclosure.

FIG. 7 illustrates an exemplary data repository in accordance with an example embodiment of the disclosure.

FIG. 8 is a block diagram illustration of a method in accordance with an example embodiment of the disclosure.

FIG. 9 is a block diagram illustration of a method in accordance with an example embodiment of the disclosure.

FIG. 10 is a block diagram illustration of a method in accordance with an example embodiment of the disclosure.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

In the following description, numerous details are set forth to provide an understanding of the present disclosure. However, it will be understood by those of ordinary skill in the art that the present disclosure may be practiced without these details and that numerous variations or modifications from the described embodiments may be possible. The disclosure will now be described with reference to the figures, in which like reference numerals refer to like, but not necessarily the same or identical, elements throughout. For purposes of clarity in illustrating the characteristics of the present disclosure, proportional relationships of the elements have not necessarily been maintained in the figures.

Specific examples pertaining to the game are provided for illustration only. The arrangement of steps in the game process or the components in the system described in respect to a mobile application for the game may be varied in further embodiments in response to different conditions, game modes, and requirements. In such further embodiments, steps may be carried out in a manner involving different graphical displays, queries, analyses thereof, and responses thereto, as well as to different collections of data. Moreover, the description that follows includes exemplary apparatuses, methods, techniques, and instruction sequences that embody techniques of the disclosed subject matter. It is understood, however, that the described embodiments may be practiced without these specific details or employing only portions thereof.

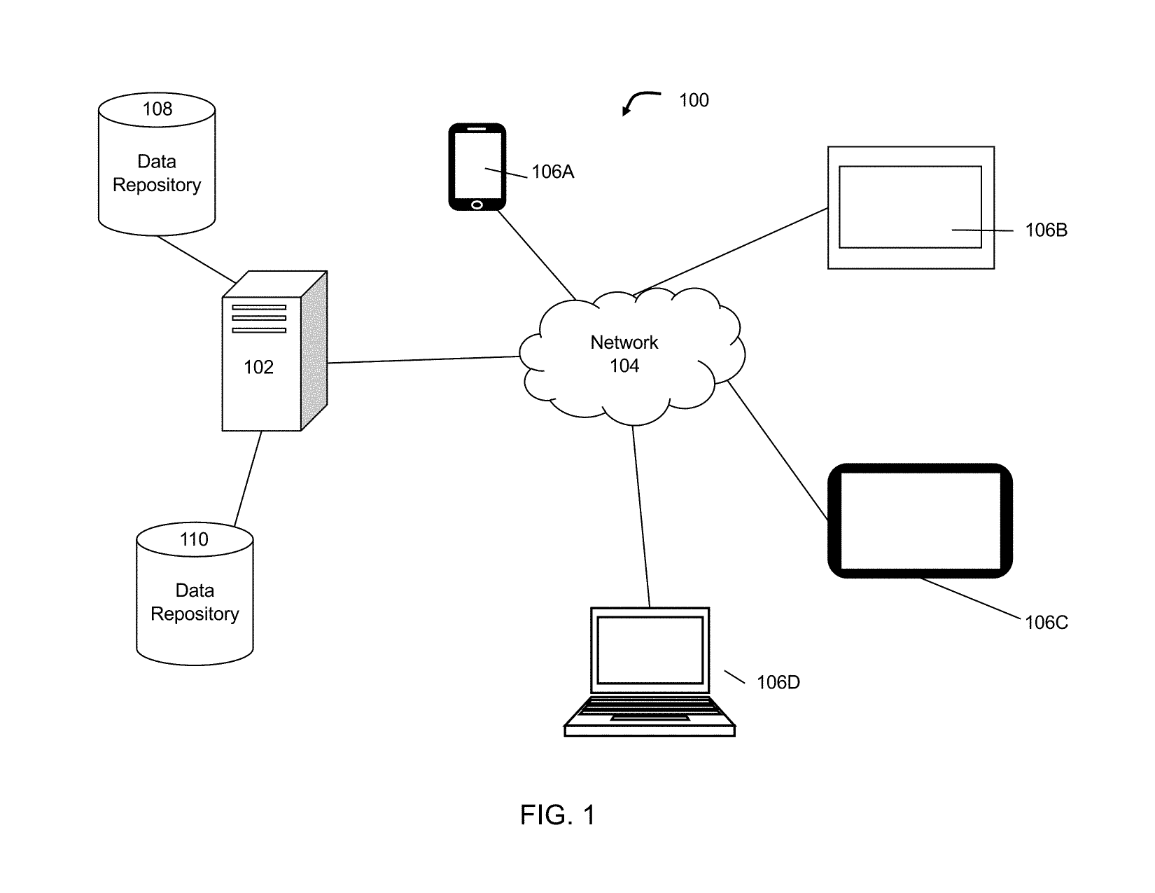

Referring now to the drawings in which like numerals represent like elements or steps throughout the several views, FIG. 1 is block diagram of exemplary environment 100 for providing a system for interactive gameplay in accordance with the present disclosure. Exemplary environment 100 may include a server 102, attached via network 104 to one or more networked devices 106A-D.

As shown server, 102 is attached to one or more data repositories 108 and 110. Data repositories 108 and 110 may include but not be limited to information about artists, bands, musicians, songs, albums, graphics, pictures, videos, digital media, vinyl recordings, digital song fingerprints, literature, works of art, movies, videos, related metadata, and one or more links to the like. Additionally, according to some embodiments of the present disclosure, data repositories 108 and 110, may include one or more sources of data and/or connections to such data such as, but not limited to, social media accounts (Facebook, Twitter, Snapchat, Instagram, Tinder, DriveTribe), user posts, user preferences, user accounts to media streaming and/or download services such as Netflix, Amazon Prime, Hulu, Audible, fantasy sports leagues, etc.

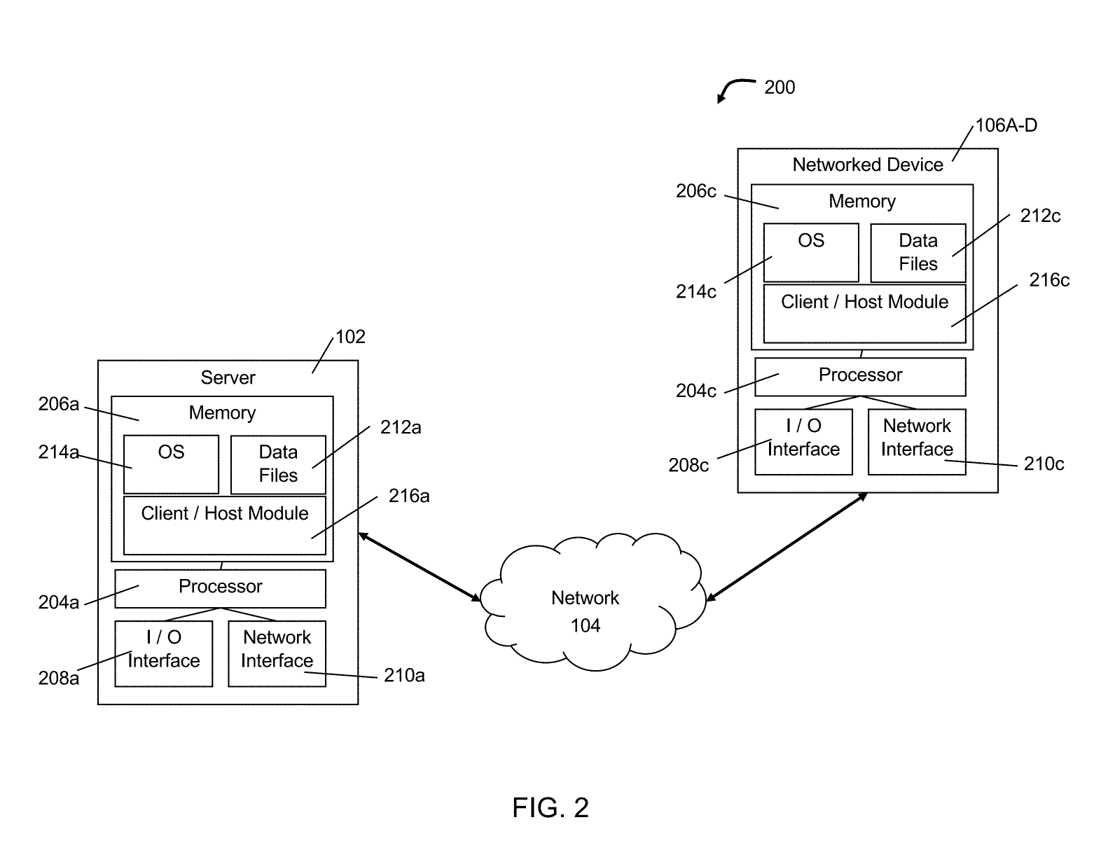

Server 102 may transmit information from one or more data repositories 108, 110 for distribution over network 104 to one or more network connected devices 106A-D. In an example embodiment, server 102 may process and provide information from data repository 108 for trivia questions about an artist or band. Server 102 may include a graphics library associated with providing design information associated with layout, fonts, colors, and the like that are associated with a game or game application. Server 102 may comprise a computing device as described below with respect to FIG. 2. Consistent with embodiments of the disclosure, server 102 may comprise one or more software applications (i.e., a series of instructions configured for execution by a processing unit) associated with another component, such as one or more servers or dedicated content devices.

Network 104 (also referred herein as distribution network or communication network) is, generally, used and implemented by a service provider (such as, but not limited to, a wired and/or wireless communication service provider) to enable the service provider to provide, and the service provider's subscribers to receive content and communication services. Network 104 additionally refers to infrastructure, including apparatuses and methods, operative and utilized to communicate data and/or signals between networked devices 106A-D. Similarly, for example and not limitation, network 104 may include current and future wired and/or wireless communication infrastructure for communicating video, audio, or other data and/or signals such as the public switched telephone communication network, cable and/or satellite telecommunications service provider communication networks, other service provider communication networks, and the Internet.

Additionally, network 104 may include any telecommunication and/or data network, whether public, private, or a combination thereof, including a local area network, a wide area network, an intranet, an internet, the Internet, intermediate hand-held data transfer devices, and/or any combination thereof and may be wired and/or wireless. Network 104 may also allow for real-time, off-line, and/or batch transactions to be transmitted between or among server 102 and networked devices 106A-D. Due to network connectivity, various methodologies as described herein may be practiced in the context of distributed computing environments.

Although networked devices 106A-D are shown for simplicity in an example embodiment as being in communication with server 102 via one intervening network 104, it is to be understood that other network configurations may be used. For example, intervening network 104 may include a plurality of networks, each with devices such as gateways and routers for providing connectivity between or among networks. Instead of, or in addition to network 104, dedicated communication links may be used to connect the various devices in accordance with example embodiments of the disclosure. For example, one or more networked devices 106A-D may form the basis of network 104 that interconnect one or more networked devices 106A-D.

As shown in FIG. 1, server 102 and networked devices 106A-D may be in communication with each other via a network such as network 104, which as described herein can include one or more separate or shared private and public networks, including the Internet or a publicly switched telephone network.

Networked devices 106A-D may include a standalone or integrated device such as a smart phone, tablet, pc, media server, television tuner, satellite or cable receiver, digital video recorder, streaming video player, video game console, Blu-ray player, and the like. Networked devices 106A-D may also include LCD display devices such as a monitor featuring an operating system, media browser, and the ability to run one or more software applications.

Server 102 is shown in communication with multiple data repositories 108, 110. Artist information may be stored in any computer readable form. Data repositories 108, 110 enable an aspect of the present system and method to retrieve information including but not limited to user account information, artists, athletes, sport teams, movies, literature, and band names for use in competition, contests, and games.

Additionally, it will be appreciated those of ordinary skill in the art that information stored in one or more data repositories 108, 100 may include data from one or more sources such as the Internet Movie Database (IMDB), Gracenote, Amazon, Goodreads, the Library of Congress, ESPN, NFL, NBA, MLB, NHL, CDDB, The Echo Nest, or data from another source such as Tribune Media Services. While illustrated as separate data repositories, it is to be understood that information included in repositories 108 and 110 may be stored in a single repository, or multiple repositories across different locations. Further according to some embodiments of the present disclosure, all or portions of information included in repositories 108 and 110 may be stored or cached locally on one or more networked devices 106A-D, and/or accessed via SQL, API, or other means.

FIG. 2 illustrates an example system 200 for supporting provision of an interactive game according to an example embodiment of the disclosure. Server 102 and Networked devices 106A-D may be any processor-driven device, such as, but not limited to, a personal computer, laptop computer, smartphone, tablet, handheld computer, dedicated processing device, and/or an array of computing devices. In addition to having processor 204, server 102 and networked devices 106A-D may further include memory 206, input/output (“I/O”) interface(s) 208, and network interface 210. Memory 206 may be any computer-readable medium, coupled to the processor, such as RAM, ROM, and/or a removable storage device for storing data files 212 and a database management system (“DBMS”) to facilitate management of data files 212 and other data stored in memory 206 and/or stored in separate databases. Memory 206 may store data files 212 and various program modules, such as operating system (“OS”) 214 and client module 216. OS 214 may be, but is not limited to, Microsoft Windows®, Apple OS X®, Apple iOS, Unix, Oracle Java®, Linux, Android, or a mainframe operating system. Client module 216 may be an Internet browser or other software, including a dedicated program, for interacting with server 102 and networked devices 106A-D.

Suitable processors, such as processors 204 of server 102 and networked devices 106A-D, respectively, may comprise a microprocessor, an ASIC, and/or a state machine. Example processors may include those provided by Intel Corporation, AMD Corporation, Qualcomm, NVidia, Broadcom, Samsung, TSMC, Apple, and Motorola Corporation. Such processors comprise, or may be in communication with media, for example computer-readable media, which stores instructions that, when executed by the processor, cause the processor to perform the elements described herein.

Generally, each of the memories and data storage devices, such as memories 204 and databases 108, 110 (as shown in FIG. 1), and/or any other memory and data storage device, can store data and information for subsequent retrieval. In this manner, systems can store various received or collected information in memory or a database associated with server 102 and networked devices 106A-D. The memories and databases can be in communication with each other and/or other databases, such as a centralized database, or other types of data storage devices. When needed, data or information stored in a memory or database may be transmitted to a centralized database capable of receiving data, information, or data records from more than one database or other data storage devices. In other embodiments, the databases shown can be integrated or distributed into any number of databases or other data storage devices.

As used herein, the term “computer-readable medium” may describe any form of memory or a propagated signal transmission medium. Propagated signals representing data and computer program instructions may be transferred between network devices and systems. Embodiments of computer-readable media include, but are not limited to, electronic, flash, optical, magnetic, or other storage or transmission device capable of providing a processor with computer-readable instructions. Also, various other forms of computer-readable media may transmit or carry instructions to a computer, including a router, private or public network, or other transmission device or channel, both wired and wireless. The instructions may comprise code from any computer-programming language, including but not limited to, for example, C, C++, C#, Visual Basic, Ruby, Java, Python, Perl, Swift, and JavaScript.

Generally, network devices and systems, server 102 and networked devices 106A-D have hardware and/or software for transmitting and receiving data and/or computer-executable instructions over a communications link and a memory for storing data and/or computer-executable instructions. These network devices and systems may also include a processor for processing data and executing computer-executable instructions locally and over network 104, as well as other internal and peripheral components that are well known in the art.

Still referring to server 102 and networked devices 106A-D, the I/O interface(s) 208 may facilitate communication between the processor 204 and various I/O devices, such as a keyboard, mouse, printer, microphone, speaker, monitor, touch screen, camera, bar code readers/scanners, RFID readers, and the like. Network interface 210 may take any of a number of forms, such as a network interface card, modem, wireless network card, embedded device, and the like. It will be appreciated that while server 102 and networked devices 106A-D have been illustrated as a single computer or processor, the server 102 and networked devices 106A-D may be comprised of a group of computers or processors, according to an example embodiment of the disclosure.

As previously mentioned, network 104 may take many forms, including a public and/or a private network, such as a cable television distribution network (e.g., a hybrid fiber-coax network), a cellular data network, a metropolitan WiMAX network, LTE, ZigBee, Bluetooth, PAN, and/or the internet.

Exemplary environment 100 shown in and described with respect to FIGS. 1 and 2 are provided by way of example only. Numerous other operating environments, system architectures, and device configurations are possible. Other system embodiments can include fewer or greater numbers of components and may incorporate some or all of the functionality described with respect to the system components shown in FIGS. 1 and 2.

For example, in one embodiment server 102 and networked devices 106A-D may be implemented as a specialized processing machine that includes hardware and/or software for performing the methods described herein. In addition, the processor and/or processing capabilities of server 102 and networked devices 106A-D, or any portion or combination thereof. Accordingly, embodiments of the disclosure should not be construed as being limited to any particular operating environment, system architecture, or device configuration.

Prior to turning to the rest of the FIGS., it should be noted that the terms “artist” and “band” are used interchangeably herein. Additionally, the terms “user” and “player” are used interchangeably, as are the terms “turn” and “round.” Moreover, the terms “prize” and “offer” are also used interchangeably. It will also be appreciated that while some aspects of the game are shown in the context of bands and musical artists, other aspects of the game in accordance with the present disclosure further include, but are not limited to sports, film, literature, art, and television.

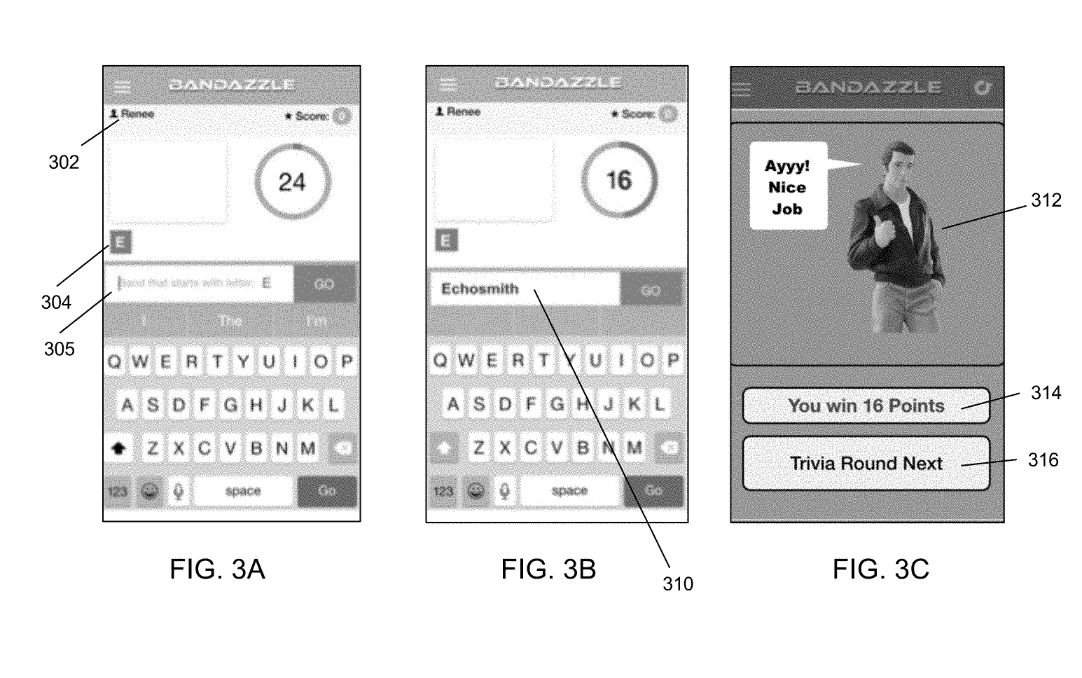

FIGS. 3A-C show exemplary screen shots of the game in accordance with one or more embodiments of the present disclosure. FIG. 3A depicts a screen shown during a letter round portion of the game. On screen 3A is player name 302, presented letter 304, and instruction 305. As shown in FIG. 3B, the player has entered and submitted response 310 (“Echosmith”) in response to presented letter 304 and instruction 305.

According to another aspect of the present disclosure, the player is presented with visual and/or auditory feedback at various times during gameplay. For example, if a player provides one or more correct answers, an animated character flies into view and cheers for the player while throwing confetti. Alternatively, when a player incorrectly answers one or more questions in the game, or is soundly outscored by a competitor, the player is presented with a character or other image to talk “smack”/provide negative feedback.

It will be appreciated that many forms of feedback may be presented to the player at various times during gameplay and such forms may include pictures of artists, athletes, actors, and characters. It will further be appreciated that the nature of the accolades and/or smack feedback may be context specific such as displaying a photograph or meme of a crying NBA hall of fame athlete for a player who has answered one or more questions incorrectly concerning basketball.

In FIG. 3C, the player is presented with an accolade image 312 and a message 314 indicating that the player has scored 16 points 314. Further shown is a message indicating that next up is the start of the trivia round 316. It will be appreciated that in accordance with certain aspects of the disclosure, letters, numbers, or other characters may be presented to a player.

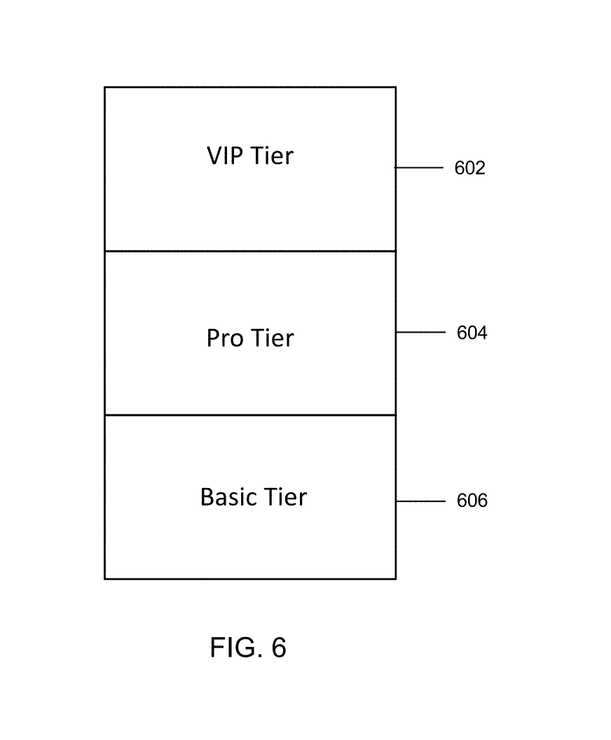

In accordance with another embodiment of the present disclosure, that additional messages may be provided to the player upon a successfully matched response. For example, FIG. 3C may inform the player that Echosmith is currently on tour and that tickets are currently on sale in a local venue and provide a link to purchase tickets such as ticket link 610 as discussed with reference to FIG. 6C.

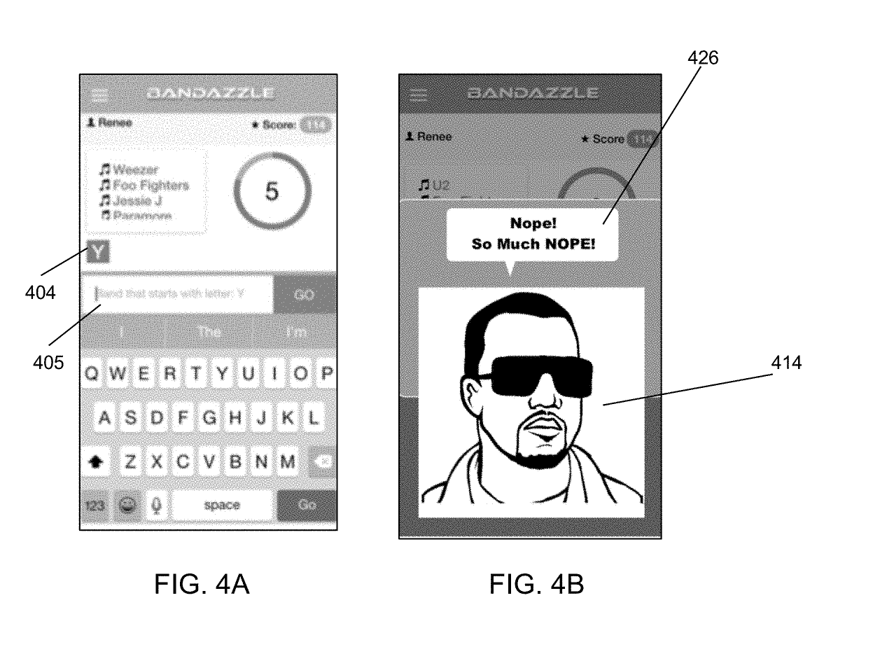

FIGS. 4 A-B show exemplary screen shots of the game in accordance with one or more embodiments of the present disclosure. In FIG. 4A, shown is presented letter 404 (“Y”) and instruction 405. According to one aspect of the disclosure, the game ends if the player fails to correctly enter a band or artist name within the allotted time limit. In FIG. 4B, message 426 indicates that the player has submitted the name of a band or artist that is not in the band information repository. Additionally, “smack” image 414 indicates that the user supplied an incorrect response and could have done better.

According to other embodiments of the present disclosure, opposing players may send a “smack” or “accolade” message such as those depicted in FIGS. 3C and 4B. It will be appreciated that various types and ratings of visual and/or audio feedback may be provided, which may be controlled in the user settings to avoid offending those users that are especially prone to being easily offended.

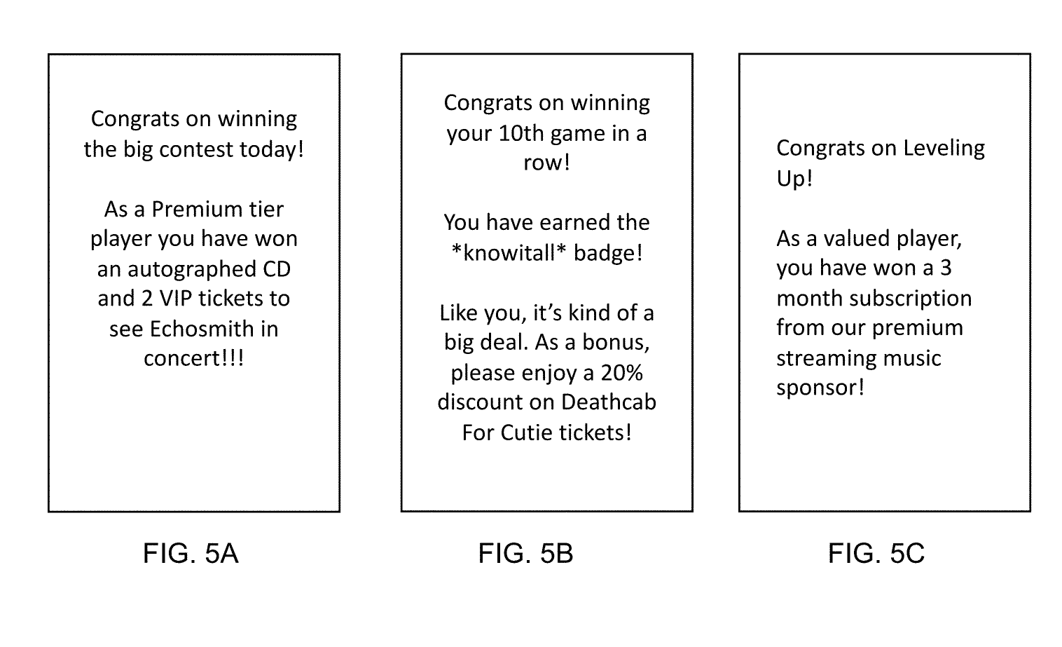

FIGS. 5 A-C show exemplary screen shots of the game in accordance with one or more embodiments of the present disclosure. FIG. 5A shows an exemplary screen shot of a prize/offer screen presented to a premium tier player. FIG. 5B shows an exemplary screen shot of a prize/offer screen presented to a non-premium tier player for winning 10 games in a row.

FIG. 5C shows an exemplary screen shot of a prize/offer screen presented to a non-premium tier player. As shown in FIG. 5B, discounts to concert tickets may include a link to primary or secondary ticket markets including but not limited to Ticketmaster, Live Nation, etix, Eventbright, Vividtickets, SeatGeek, and Stubhub. According to some embodiments of the present disclosure, player geographic location information is provided along with the selected artist to the selected ticket vendor.

FIG. 6 illustrates an exemplary user tier system in accordance with one or more embodiments of the present disclosure. As shown, 602 illustrates a VIP or premium tier such as may include players who have paid a subscription for the game or have a subscription with one or more media partners. 604 illustrates a Pro tier such as may include players who consistently take part in contests, have amassed a certain number of achievements in the game, or just those players who actively play the game. 606 represents the basic tier as

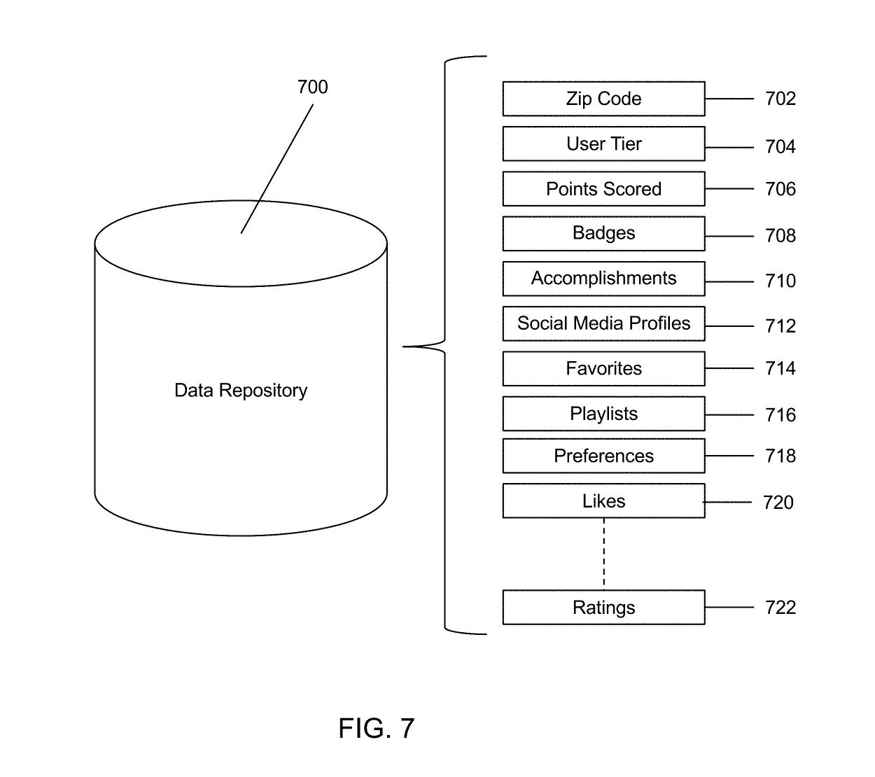

FIG. 7 illustrates an exemplary data repository in accordance with an example embodiment of the disclosure. As shown, data repository 700 includes multiple player or user parameters. Examples include, zip code 702, User tier 704, points scored 706, badges 708, accomplishments 710, social media profiles 712, favorites 714, playlists 716, preferences 718, likes 720, and ratings 722. As previously mentioned with respect to data repositories 108 and 100, Additionally, according to some embodiments of the present disclosure, data repositories 108 and 110, may include one or more sources of data and/or connections to such data such as, but not limited to social media accounts and the like.

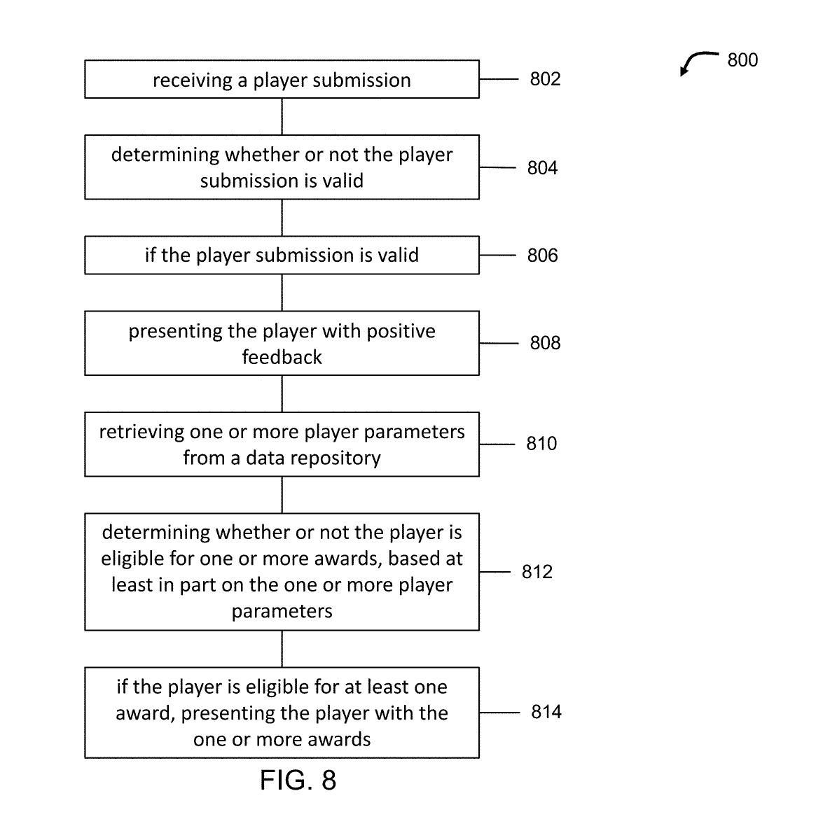

FIG. 8 is a flow diagram illustration 800 for providing an incentive to a player of a game on a computing device in accordance with an example embodiment of the disclosure. In block 802, the step of receiving a player submission is carried out. In block 804, the step of determining whether or not the player submission is valid is performed. In block 806, if the player submission is valid, then the step of block 808 is performed by presenting the player with positive feedback. In block 810, the step of retrieving one or more player parameters from a data repository is carried out. In block 812, the process of determining whether or not the player is eligible for one or more awards, based at least in part on the one or more player parameters is performed. In block 814, if the player is eligible for at least one award, the step of presenting the player with the one or more awards is carried out. It will be appreciated by one of skill in the art, that according to some embodiments, additional steps may be carried out such as the step of, if the player submission is not valid, presenting the player with negative feedback.

Examples of player parameters may include a zip code 702, or other geographical user preference such as a 100-mile preference for nearby concert venues. For instance, it may be determined that there are a pair of free VIP concert tickets available as a player prize in a certain area. If the player is eligible for a prize and the VIP concert tickets are within a reasonable proximity to the player's geographical user parameter, then the player may be awarded those tickets as a prize.

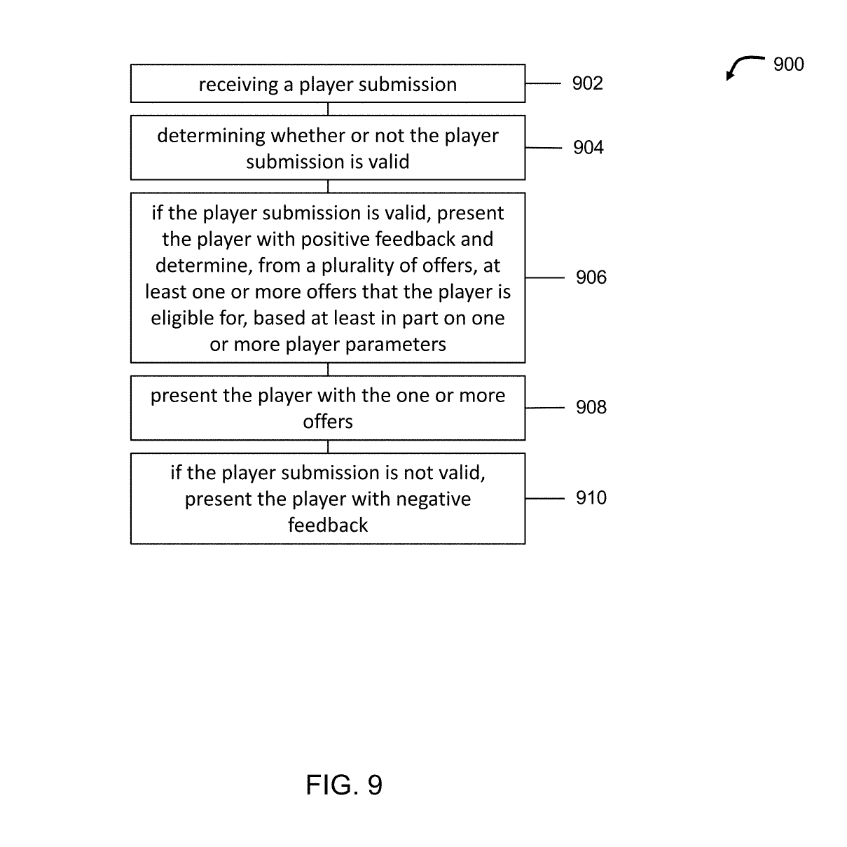

FIG. 9 is a flow diagram illustration 900 for providing an incentive to a player of a game on a computing device according to an alternate example embodiment of the disclosure. In block 902 the step of receiving a player submission is performed. In block 904, the step of determining whether or not the player submission is valid is carried out. In block 906 if the player submission is valid, the step of presenting the player with positive feedback and determine, from a plurality of offers, at least one or more offers that the player is eligible for, based at least in part on one or more player parameters. Examples of positive feedback, such as accolades shown in FIG. 3C. In block 908, the step of presenting the player with the one or more offers is performed. In block 910, if the player submission is not valid, the step of presenting the player with negative feedback is performed. Examples of negative feedback include the smack screen depicted in FIG. 4B.

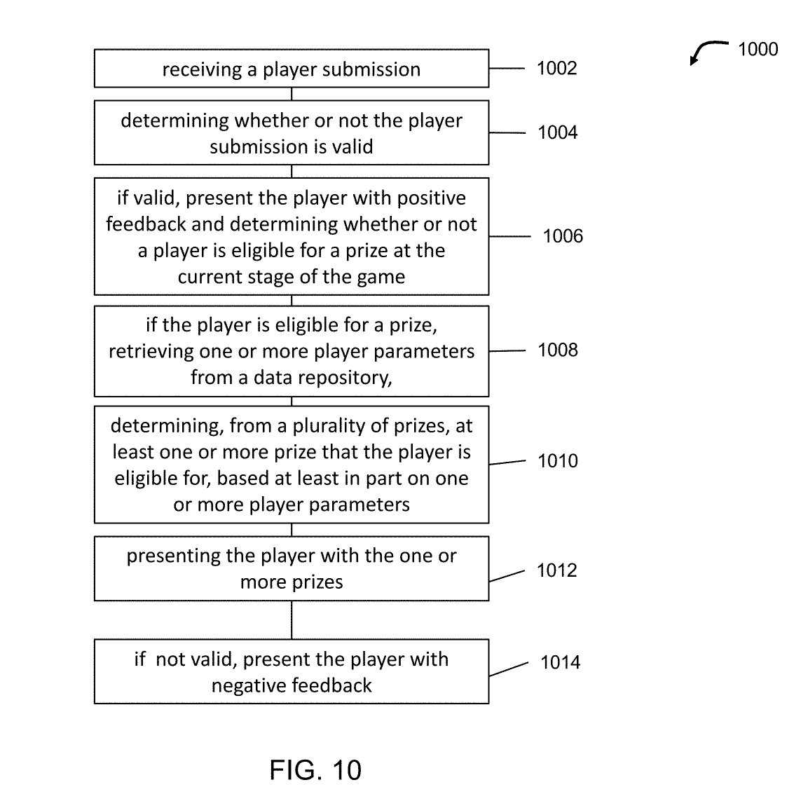

FIG. 10 is a flow diagram illustration 1000 for providing an incentive to a player of a game on a computing device according to an alternate example embodiment of the disclosure. In block 1002 the step of receiving a player submission is performed. In block 1004, the step of determining whether or not the player submission is valid is carried out. In block 1006, the step of if valid, present the player with positive feedback and determining whether or not a player is eligible for a prize at the current stage of the game is carried out. Examples of information included in this determination include but are not limited to determining if the game is over, if the player completed a level, if the player has unlocked an achievement and the like. It will be appreciated that the prize/offer/award may be presented to the player at the end of a game, at the start of the game, or at any point between.

In block 1008 if the player is eligible for a prize, retrieving one or more player parameters from a data repository. In block 1010, the step of determining, from a plurality of prizes, at least one or more prize that the player is eligible for, based at least in part on one or more player parameters. In block 1012, the step of presenting the player with the one or more prizes is carried out. In block 1014, if the player submission is not valid, then the step of presenting the player with negative feedback is carried out. As previously explained, negative feedback may take the form of smack talk such as shown in FIG. 4B.

According to an embodiment of the game according to the disclosure, a social challenge mode is provided whereby players can play random users or challenge friends such as Facebook, Game Center friends, or a registered player with an account. According to some embodiments of the present disclosure, in match play, a player must complete their turn within a specified number of days, such as 2 days, to avoid forfeiting the game.

According to some embodiments of the present disclosure, a player may interact with one or more social media platforms through the game. For example, a player may post to Facebook after winning a game, after answering a trivia question correctly, when an achievement is reached, when a badge is won, or to share a trivia question. Posts to social media through the game include links which allow a third party user to click to be directed to the interactive game, or in some instances, to launch the game application on a device.

According to some embodiments of the present disclosure, the game may be played on a hand-held device such as a smart phone, tablet, and the like, or a digital computing device such as notebook, laptop, desktop, gaming console, dvr, game console, or web browser. According to one embodiment, the game is included as an application on a computing device such as a smart phone or tablet application.

According to another aspect of the disclosure, a player is presented with several game modes including the ability to play against the computer, against a friend, or against a community of players. According to some embodiments of the present disclosure, during game play, the mobile device may detect the geographic vicinity of the player and begin to stream content from the local radio station to the networked device 106A-D. For example, in accordance with one or more embodiments of the present disclosure, if the user has chosen country music as their genre preference and they live in San Antonio, then local iHeart Radio station KAJA may begin to play in the background. According to another embodiment of the present disclosure, advertising for the local station such as banners, will be displayed on a portion of the screen.

Login and Player Accounts. According to an embodiment of the present disclosure, the player may login to the game using email and password or via third party account/social login. Examples of third party accounts logins include Facebook, Instagram, Google+, Twitter, LastFM, Apple Game Center, Microsoft Xbox Live, Steam, Sony PlayStation Network, Nintendo Network ID, Hyves, LinkedIn, LiveJournal, Myspace, Renren, Yahoo!, WordPress, PayPal, AOL, Foursquare, and Open ID. It will be appreciated by one of ordinary skill in the art that third party logins may make be implemented using one or more authentication APIs and secure system standards including OAuth.

According to another embodiment of the present disclosure player accounts include name, username, profile picture, email address, geographic location, music genre preference, online music account credentials (such as Spotify, Pandora, Apple Music,). It will be appreciated that certain embodiments of the game may provide commercial free music streaming music if credentials are provided, but will provide music streaming with commercials if no online music account credentials are provided.

Other embodiments the game may include:
1. Players are ranked daily and the high scorers may win “meet and greets”, backstage passes, preferred seats at shows, or similar incentives;
2. Random trivia from the bands maybe presented to the player for additional points and deeper gaming experience;
3. At the end of the game, each band chosen is shown in a list and the gamer can click on the scroll to see what's going on with the band;
4. Each band in the list includes one or more links to band website, touring schedule, merchandise, videos, music downloads, and Wikipedia.

Certain embodiments of the game reward players for achievements. By way of example and not limitation, according to some embodiments, players may receive credit/coins for reaching achievements based on server date and time for: first day play, 7 days in a row, 14 days in a row, 30 days in a row, 30 nonconsecutive days, 60 nonconsecutive days, 100 nonconsecutive days, 150 nonconsecutive days, and 250 nonconsecutive days. Additionally, players may be rewarded with credit/coins for winning a first game, 10 games in a row, 25 games in a row, 25 games, 50 games, 100 games, 10 Challenges, 25 Challenges, 50 Challenges, 100 Challenges, and 250 Challenges. It will be appreciated that credit/coin amounts may vary depending on the relative importance of an achievement. Some embodiments of the game show the player's progress towards an achievement. For example, if the player plays 4 days in a row, the game shows that the player has 3 days left to accomplish a 7 days in a row achievement. Additionally, when a player gains a coin or coins, or completes an achievement, an acknowledgement screen alerts the player that they have gained coins or earned an achievement.

In addition to achievements, some embodiments of the game reward players with badges based at least in part, upon player scores both cumulatively and per game. Examples of player badges include Fan, Front Row, Groupie, Opening Act, Pre-Show, Meet & Greet, VIP, All Access, Star, Super Star, Living Legend, Hall of Fame, and Kind of a Big Deal. In accordance with another embodiment of the present disclosure, badges or coins may be awarded to players for submitting trivia questions and answers for use in the game. It should be noted that the terms reward, offer, prizes, and awards are used interchangeably.

Portions of player usage information may be provided to the third party service to such a platform to increase usage, advertising value, etc. Thus, it is further contemplated that the gaming application can serve as a source for commercial revenue streams such as the following:
1. Ad sales
   a. Banner
   b. Pop up
   c. Start up
   d. Result page/National & Regional
2. Single/Album sales
3. Ticket sales
4. Merchandise sales
5. Premium paid APP
6. Highlight fees. Marketing tools for labels, artists, and promoters.
7. Sell trending data and game metrics.
8. Increase company usage to increase ad value to company sales team.

Notwithstanding the above, the present disclosure relies on a generally computer-implemented and/or software-implemented process of playing a music or band-related game. Accordingly, the flowcharts of FIGS. 8-10 generally illustrate systems and methods according to one or more embodiments in accordance with the present disclosure.

The computing device includes and communicates with a resident processor(s) and memory storing programmable instructions executable to initiate or perform various steps in the process. These programmable instructions are packaged in a software application that can be initiated from or in the computing device. In any event, the computing device includes a graphical user interface to the software application responsive to input by the user and capable of projecting output displays and other activity generated by the application.

The flow chart of FIGS. 8-10 shows the architecture, functionality, and operation of a possible implementation of providing an interactive game. In this regard, each block represents a module, segment, or portion of code, which comprises one or more executable instructions for implementing the specified logical function(s). It should also be noted that in some alternative implementations, the functions noted in the blocks may occur out of the order noted in FIGS. 8-10. For example, two blocks shown in succession in FIGS. 8-10 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discreet logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present disclosure has been described in detail, it should be understood that various changes, substitutions and alterations can be made thereto without departing from the spirit and scope of the disclosure as defined by the appended claims.

The foregoing description has been presented for purposes of illustration and description. It is to be noted that the description is not intended to limit the invention to the various systems, apparatus, processes, media, and graphical user interfaces disclosed herein.

What is claimed is:

1. A method of providing an incentive to a player of a game on a computing device comprising the steps of:
receiving a player submission;
determining whether or not the player submission is valid;
if the player submission is valid:
presenting the player with positive feedback;
retrieving one or more player parameters from a data repository;
determining whether or not the player is eligible for one or more awards, based at least in part on the one or more player parameters;
if the player is eligible for at least one award;
presenting the player with the one or more awards; and
if the player submission is not valid, presenting the player with negative feedback.

2. The method of claim 1 wherein the step of determining whether or not the player is eligible for one or more awards is based at least in part on a player geographical preference parameter.

3. The method of claim 1 wherein the step of determining whether or not the player is eligible for one or more awards is based at least in part on a player geographical preference parameter and a user tier parameter.

4. The method of claim 1 further including the step of, if the player submission is valid, presenting the player with a message about the player submission with one or more of, links to purchase concert tickets, links to purchase music, or links to stream music.

5. The method of claim 4 wherein the player is further presented with one or more of the following: links to the artist website, links to purchase concert tickets, and links to purchase music by an artist.

6. The method of claim 1 wherein at least one of the awards includes tickets to an event.

7. A system for providing an incentive to a player of a game on a computing device comprising:
at least one memory operable to store computer-executable instructions;
at least one communications interface to access the at least one memory; and
at least one processor configured to access the at least one memory via the at least one communications interface and execute the computer-executable instructions to:
receive a player submission;
determine whether or not the player submission is valid;
if the player submission is valid, present the player with positive feedback and determine, from a plurality of offers, at least one or more offers that the player is eligible for, based at least in part on one or more player parameters;
present the player with the one or more offers; and
if the player submission is not valid, present the player with negative feedback.

8. The system of claim 7 wherein the computer-executable instructions to determine whether or not the player is eligible for one or more offers is based at least in part on a player geographical preference parameter.

9. The system of claim 7 wherein the computer-executable instructions to determine whether or not the player is eligible for one or more offers is based at least in part on a player geographical preference parameter and a user tier parameter.

10. The system of claim 7 further comprising computer-executable instructions to, if the player submission is valid, present the player with a message about the player submission with one or more of, links to purchase concert tickets, links to purchase music, or links to stream music.

11. The system of claim 10 further comprising computer-executable instructions to present the player with one or more of the following: links to the artist website, links to purchase concert tickets, and links to purchase music by an artist.

12. The system of claim 7 wherein at least one of the offers includes tickets to an event.

13. A method of providing an incentive to a player of a game on a computing device comprising the steps of:
receiving a player submission;
determining whether or not the player submission is valid;
if the player submission is valid:
presenting the player with positive feedback;
determining whether or not a player is eligible for a prize at the current stage of the game;
if the player is eligible for a prize;
retrieving one or more player parameters from a data repository;
determining, from a plurality of prizes, at least one or more prize that the player is eligible for, based at least in part on one or more player parameters; and
presenting the player with the one or more prizes.

14. The method of claim 13 further comprising the step of if the player submission is not valid, presenting the player with negative feedback.

15. The method of claim 13 wherein the step of determining whether or not the player is eligible for one or more prizes is based at least in part on a player geographical preference parameter.

16. The method of claim 13 wherein the step of determining whether or not the player is eligible for one or more prizes is based at least in part on a player geographical preference parameter and a user tier parameter.

17. The method of claim 13 further including the step of, if the player submission is valid, presenting the player with a message about the player submission with one or more of, links to purchase concert tickets, links to purchase music, or links to stream music.

18. The method of claim 13 wherein at least one of the prizes includes tickets to an event.

19. The method of claim 13, wherein one or more of the steps are performed on a server.

20. The method of claim 13 wherein one or more of the steps are performed on a networked device.
